(19) United States
(12) Patent Application Publication
(10) Pub. No.: US 2026/0320338 A1
(43) Pub. Date: Oct. 15, 2026

(54) Device and Method

(71) Applicant: Freevolt Technologies Limited, London (GB)

(72) Inventors: Vitor FREITAS, London (GB); Victor DIAZ, London (GB); Alison LLOYD, London (GB)

(21) Appl. No.: 19/104,300

(22) PCT Filed: Aug. 17, 2023
(86) PCT No.: PCT/GB2023/052159

§ 371 Date: Feb. 17, 2025

(30) Foreign Application Priority Data
Aug. 17, 2022 (GB) 2211992.9

(51) Int. Cl. G06K 19/073; G06K 19/07

(52) U.S. Cl. CPC G06K 19/07354; G06K 19/0701

(57) ABSTRACT

The present disclosure provides a near field RF communications device configured to communicate with other RF communication devices according to one or more RF communication protocols. The device may be a receiver, such as a card, and it contains auxiliary circuitry, such as an authorisation sensor. The device is configured to interact with another RF device, such as a reader, to prompt that other RF device to continue providing an H-field from which the device may harvest power. This harvested power is initially used for operating the auxiliary circuitry to determine whether or not to further communicate with the reader. If data obtained using the auxiliary circuitry indicates that the device should proceed to further communicate with the other device, then the device will switch into a different mode of operation in which it communicates with that other device according to an RF communication protocol.

### TECHNICAL FIELD

The present disclosure relates to field of near field radiofrequency (‘RF’) communications devices and methods. In particular, the present disclosure relates to the field of RF devices and methods for controlling communication between one RF device and another RF device according to one or more RF communication protocols.

### BACKGROUND

Smartcards, also known as chip cards, or integrated circuit cards (‘ICC’), are increasingly prevalent. A wide variety of such pocket-sized cards with embedded integrated circuits are in use in a wide variety of applications. The most frequent uses of such cards relate to financial transactions, mass transit systems, and access control. Smart cards are made of plastic, generally polyvinyl chloride, but sometimes polyethylene-terephthalate-based polyesters, acrylonitrile butadiene styrene or polycarbonate. Reusable smart cards may also be made from paper. Such cards often incorporate an integrated circuit, IC, and some source of power such as a near field RF communications interface for powering the IC and providing data communications to and from it.

An IC device, also referred to as a ‘chip’, traditionally consists of a single semiconductor die which has a particular function and which is adapted to interact with other chips and components. For example, a traditional chip might be a microprocessor, a memory controller, or a memory array. IC systems may include two or more chips, as well as other electronic and electrical components, each attached to and interconnected through a mounting system such as a printed circuit board.

The ability of near field RF communications devices to be passively powered is a significant benefit. Some near field communicator chips also provide auxiliary power outputs. This can enable power harvested by the near field RF communicator to be used by other circuits.

Biometric enabled smartcards are based on providing a service depending on the validity of biometric data, such as a fingerprint. A common application is to selectively allow/deny access to the data stored on a near field RF communicator (sometimes called a “tag”) embedded in the smartcard, or to the RF communicator itself, dependent on validation/authentication of the biometric data. In order to make this system work, the tag must be hidden from the outside world until the fingerprint has been authenticated.

Next generation smartcards, such as biometric smartcards, need:
More power than standard smartcards
Power for longer than a basic NFC smartcard

On the other hand, some readers, especially in the access control market, don't emit a constant field, but instead a pulsed one; this is particularly evident when there is no corresponding card to communicate with, with the reader emitting only very short search pulses. This makes it very difficult to rely on power harvested from the reader to power biometric functions on the card, or other functions that precede communication.

This means that some kind of energy storage is needed for the time that the field is off, to allow for biometric capture, processing and verification.

The usual go-to solution is to use batteries (either rechargeable or primary), but this presents the following issues:
Environmental and recyclability problems which may be unacceptable for a mass-produced item such as a payment card or access control card.
Storage limitations (e.g. Lithium cell acceptable temperature range).
Finite life span of the product due to primary discharge or secondary aging.
If they are rechargeable, usually the admitted current for charging is around 1 C (C being the capacity of the battery), which considering the very small size of the battery used (10-15 mAh is typical), most of the harvested power goes to waste, and so charging is inefficient.
Increased manufacturing complexity and cost.

The provision of a reliable power supply in a system such as a smartcard therefore represents a particular problem.

### SUMMARY

Aspects of the disclosure are set out in the independent claims and optional features are set out in the dependent claims. Aspects of the disclosure may be provided in conjunction with each other, and features of one aspect may be applied to other aspects.

In an aspect, there is provided a near field RF communications enabled device comprising: a coupler for connecting to a near field RF communications antenna for inductive coupling with an H-field provided from another near field RF communications enabled device in near field range; auxiliary circuitry operable to obtain auxiliary data; an RF communicator comprising stored instructions for communicating with a said another near field RF communications enabled device according to at least one RF communication protocol; and a controller operable to selectively connect the RF communicator to the coupler for communicating with said another near field RF communications device according to a stored RF communication protocol. The device is configured to operate in: a spoofing mode in which a spoofing signal is applied to at least one component of the device to cause said another RF communications device to maintain or increase the H field; and an RF communications mode in which the RF communicator is connected to the coupler to communicate with said another RF communications device according to an RF communication protocol. The controller is configured to control the device to operate in the spoofing mode until the device has harvested enough power from the H field of said another RF communications device for the auxiliary circuitry to obtain auxiliary data. The controller is configured to determine if the obtained auxiliary data satisfies a threshold criterion, and in the event that it does, the controller is configured to connect the RF communicator to the coupler to switch the device into the RF communications mode to communicate with said another RF communications device according to a stored RF communications protocol.

Embodiments may provide a near field RF communications device which is quicker and/or more efficient at obtaining auxiliary data. In particular, devices of the present disclosure may find particular utility for implementing higher power consuming circuitry on a passive device. For example, an authorisation sensor, such as a fingerprint scanner, may be powered by energy harvested from the H field of said another RF device, and the devices of the present disclosure may be configured to operate in the spoofing mode to cause the reader to maintain its H field so that energy can keep being harvested therefrom for powering such a sensor. Devices of the present disclosure may thus interact with the reader to cause that reader to maintain its H field for long enough that enough energy may be harvested for the auxiliary circuitry to obtain the auxiliary data, and for the controller to determine if the auxiliary data satisfies the selected criterion. At which point, if the criterion is satisfied (e.g. if the user is authorised), the device may then initiate communication with the reader using the RF communicator (where that communication may then follow an RF communications protocol).

The auxiliary circuitry may comprise authentication circuitry operable to obtain authentication data for a user interacting with the device. The selected criterion may be an authentication criterion. The controller may be configured to determine that the obtained auxiliary data satisfies the threshold criterion in the event that the obtained authentication data indicates that said user interacting with the device is an authenticated user. The authentication circuitry may comprise an authentication sensor. The authentication circuitry may be configured to obtain authentication data for a user interacting with the authentication sensor. The authentication sensor may comprise a biometric sensor, such as a fingerprint sensor, and the auxiliary data may comprise biometric data for a user interacting with the biometric sensor (e.g. fingertip data for a user's fingertip contacting the sensor).

The device may comprise switching circuitry. Applying a spoofing signal to a component of the device may comprise applying a control signal to at least one switch of the switching circuitry to open or close said switch. Said switch may be arranged to cause an impedance of the device to change in response to that switch being opened and/or closed, and/or wherein said switch is arranged to connect the coupler to local oscillator circuitry of the device, or to a component coupled to the local oscillator circuitry, when closed. For example, applying the control signal may comprise applying a signal so as to cause a subsequent change to the operating conditions of the device which is detectable by said another RF device (e.g. which will manifest in a detectable change to the propagation environment of the H field provided by that device). Said switch may be connected to a component of an antenna input impedance matching network of the device. Opening and/or closing the switch may cause a change in impedance of the device. The device may comprise a rectifying element arranged to harvest power from RF signals received at a said antenna connected to the antenna. The device may be configured to provide the impedance changes at a location upstream of an output of the rectifying element (e.g. between the element and the coupler). For example, said switch may arranged between said antenna and the rectifying element, and/or said switch may be connected to a component arranged between said antenna and the rectifying element.

The RF communicator may comprise stored secure data. The device may be arranged to inhibit communication of said secure data to said another RF communications device until after the auxiliary data has been obtained and that obtained auxiliary data satisfies the threshold criterion. The device may be arranged to inhibit the RF communicator initiating communication with said another near field RF communications device according to an RF communication protocol until after the auxiliary data has been obtained (and that obtained auxiliary data satisfies the threshold criterion). The device may comprise a spoof RF communicator. The device may be configured to use the spoof RF communicator to communicate with said another RF communications device when operating in the spoofing mode. In the event that the obtained auxiliary data satisfies the threshold criterion, the controller may be configured to connect the RF communicator to the coupler to communicate with said another RF communications device thereby to operate the device in the RF communications mode.

The device may comprise local oscillator circuitry. The controller may be configured to control operation of the local oscillator circuitry to operate the device in the spoofing mode. Operating the device in the spoofing mode may comprise at least one of: (i) operating the local oscillator circuitry to provide an RF signal to the coupler to actively transmit said RF signal to said another RF communications device, (ii) operating the local oscillator circuitry to selectively connect or disconnect another component of the device to the antenna (e.g. to selectively connect an impedance changing element of the device to the antenna according a timing pattern selected by the local oscillator circuitry). The local oscillator circuitry may comprise phase sensing circuitry configured to provide phase synchronisation for operation of the local oscillator circuitry. For example, the local oscillator circuitry may be controlled to operate based also on a phase of the signals generated by said another RF communications device, e.g. to provide a selected phase difference relative to those signals generated by said another RF communications device. In other words, the device may be configured to phase match local oscillator signals with phase of signals associated with said another RF communications device.

The device may comprise a switching system operable to: (i) selectively connect the RF communicator to said antenna, and/or (ii) selectively connect the local oscillator circuitry, or a component coupled to the local oscillator circuitry, to said antenna. The device may be configured to control operation of the switching system to initially connect the local oscillator circuitry, or said component coupled to the local oscillator circuitry, to said antenna, optionally with the controller disconnected from said antenna. The device may be configured to keep the local oscillator circuitry, or said component coupled to the local oscillator circuitry, connected to said antenna while operating in the spoofing mode. The device may be configured to control operation of the switching system to disconnect the local oscillator circuitry, or said component coupled to the local oscillator circuitry, from said antenna once the auxiliary data has been obtained. In the event that the obtained auxiliary data satisfies the threshold criterion, the device may be configured to control operation of the switching system to disconnect the local oscillator circuitry, or said component coupled to the local oscillator circuitry, from said antenna and to connect the RF communicator to said antenna. The device may further comprise an oscillator controller configured to control operation of the local oscillator circuitry.

The RF communicator may comprise stored instructions for communicating with a said another near field RF communications enabled device according to an NFC communication protocol. The device may be configured to: (i) first apply a spoofing signal to a switch of the switching circuitry to control the local oscillator circuitry to operate in the spoofing mode, (ii) apply a spoofing signal to a switch of the switching circuitry to cause a change in impedance to the device, and (iii) then to connect RF communicator to the coupler to switch the device into the RF communications mode. For example, the device may be configured to: (i) first apply a spoofing signal to a switch of the switching circuitry to cause the local oscillator circuitry of the device to transmit an RF signal to said another RF communications device via said antenna, (ii) apply a spoofing signal to a switch of the switching circuitry to cause a change in impedance to the device, and (iii) then to connect RF communicator to the coupler to switch the device into the RF communications mode. The device may comprise a spoofing controller. The spoofing controller may be configured to control the application of the spoofing signal to said at least one component when the device is operating in the spoofing mode. The RF communicator and the controller may be provided by the same component.

The device may comprise phase detection circuitry configured to detect a frequency of an incoming RF signal from a said another near field RF communications enabled device. The phase detection circuitry may be configured to output a signal having a frequency based on the frequency of the incoming RF signal. The phase detection circuitry may comprise a frequency divider configured to reduce a frequency of the incoming RF signal to provide the output signal. The device may be configured to apply the output signal as the spoofing signal. The device may be configured to apply the output signal to control operation of at least one switch. Said switch may be arranged to selectively electrically connect a selected impedance to a said antenna. The selected impedance may have an impedance value selected based on an impedance value of an RF communicator. The incoming RF signal may be a carrier signal.

Although the term “spoofing” is used herein, operation in the spoofing mode may comprise operating in a “reader prompting” mode, in which operation of the device is such that it prompts the reader to maintain or increase its H-field. Likewise, the term “connect” or “connection” is used herein in relation to electrical connections between different components of the device. Such connection may provide a corresponding electrical connection, i.e. which enables current to flow between the different components. The connection may be direct (e.g. the two components may be immediately connected to each other) or indirect (e.g. the two components may be connected via one or more other components to each other).

In an aspect, there is provided a near field RF communications apparatus comprising: a first near field RF communications enabled device operable to provide an H-field for near field communication with another RF communications device; and a second near field RF communications enabled device configured for inductive coupling with said H-field; wherein the second RF communications device is configured to operate in a spoofing mode and an RF communications mode; and wherein the first RF communications device is configured to determine whether the second RF communications device is operating in the spoofing mode, and in the event that it is determined that the second RF communications device is operating in the spoofing mode, the first RF communications device is configured to maintain or increase its H-field. The second near field RF communications device may comprise any device disclosed herein. The first near field RF communications device may comprise a reader. The reader may be configured to continue providing its H-field for a selected amount of time after determining that the device is operating in a spoofing mode. The selected amount of time may comprise a time period of sufficient length for the authorisation process to finish. For example, the reader may maintain (or increase) the H-field until the device initiates communication according to an RF communication protocol or until the device stops attempting to communicate with the reader. Alternatively, the reader may continue providing its H-field for a preset amount of time. In the event that no RF communication protocol is initiated in that time period, then the reader may stop maintaining its H-field. The reader may have one or more stored indications of spoofing mode operations, and the reader may be configured to determine that the second RF communications device is operating in a spoofing mode in the event that the behaviour of the second RF communications device (e.g. the changes in impedance thereof) correspond to a stored indication of spoofing operation.

In an aspect, there is provided a near field RF communications device configured to provide an H-field for near field communication with another RF communications device; wherein the RF communications device is configured to determine whether a said another RF communications device inductively coupling with the device is operating in a spoofing mode, and in the event that it is determined that said another RF communications device is operating in the spoofing mode, the RF communications device is configured to maintain or increase its H-field.

In an aspect, there is provided a near field RF communications method for controlling operation of a near field RF communications enabled device comprising: a coupler for connecting to a near field RF communications antenna for inductive coupling with an H-field provided from another near field RF communications enabled device in near field range, and auxiliary circuitry operable to obtain auxiliary data, wherein the method comprises: operating the device in a spoofing mode in which a spoofing signal is applied to at least one component of the device to cause said another RF communications device to maintain or increase the H field, wherein the device is operated in the spoofing mode until it has harvested enough power from the H field of said another RF communications device for the auxiliary circuitry to obtain auxiliary data; determining if the obtained auxiliary data satisfies a threshold criterion, and switching the device into an RF communications mode to communicate with said another RF communications device according to an RF communication protocol.

In an aspect, there is provided a near field RF communications method comprising: operating a first near field RF communications enabled device to provide an H-field for near field communication with another RF communications device; controlling a second near field RF communications device to inductively couple with said H-field, wherein the second RF communications device is configured to operate in a spoofing mode and an RF communications mode; and operating the first RF communications device to determine whether the second RF communications device is operating in the spoofing mode, and in the event that it is determined that the second RF communications device is operating in the spoofing mode, maintaining or increasing the H-field provided by the first near field RF communications device.

Aspects of the present disclosure may provide computer program products comprising computer program instructions configured to program a controller to control operation of a near field RF communications enable device to perform any method disclosed herein.

### FIGURES

Some examples of the present disclosure will now be described, by way of example only, with reference to the figures, in which:

FIG. 1 is a schematic diagram illustrating a near field RF communications enabled device.

FIG. 2 is a schematic diagram illustrating a near field RF communications enabled device.

FIG. 3 is a schematic diagram illustrating a near field RF communications enabled device.

FIG. 4 is a schematic diagram illustrating a near field RF communications enabled device.

FIG. 5 is a schematic diagram illustrating a near field RF communications enabled device.

FIG. 6 is a schematic diagram illustrating a near field RF communications enabled device.

FIG. 7 is a schematic diagram illustrating a near field RF communications enabled device.

FIG. 8 is a schematic diagram illustrating a near field RF communications enabled device.

In the drawings like reference numerals are used to indicate like elements.

### SPECIFIC DESCRIPTION

Embodiments provide a near field RF communications device configured to communicate with other RF communication devices according to one or more RF communication protocols. The device may be a receiver, such as a card, and it contains auxiliary circuitry 60, such as an authorisation sensor. The device is configured to interact with another RF device, such as a reader, to cause that other RF to continue providing an H-field from which the device may harvest power. This harvested power is initially used for operating the auxiliary circuitry 60 to determine whether or not to further communicate with the reader. If data obtained using the auxiliary circuitry 60 indicates that the device should proceed to further communicate with the other device, then the device will switch into a different mode of operation in which it communicates with that other device according to an RF communication protocol.

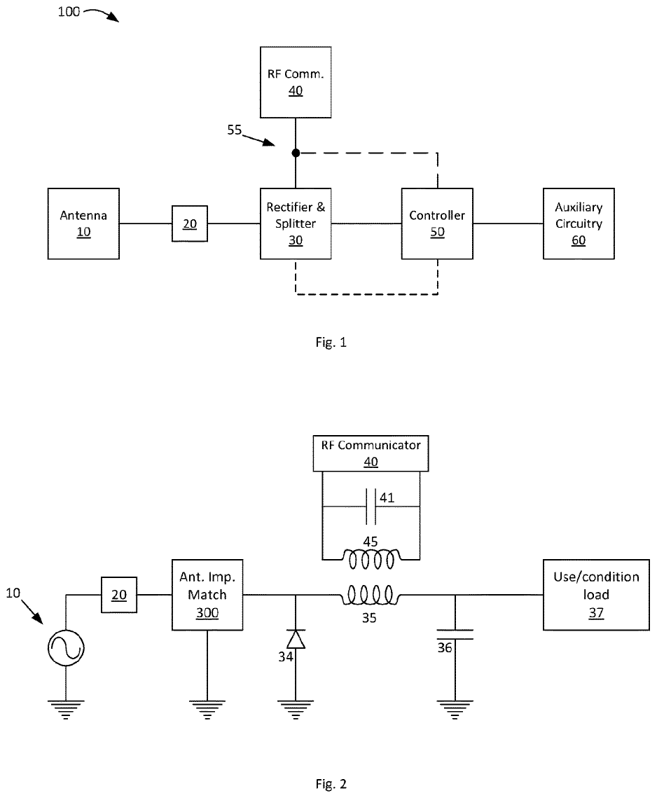

An example RF communications device will now be described with reference to FIG. 1.

FIG. 1 shows a near field RF communications device 100. In the example of FIG. 1, the device 100 is a smart card. The smart card provides an RF receiver (or ‘tag’). The receiver is configured to interact with other near field RF communications devices, and in particular, the receiver is configured to interact with RF readers. The RF receiver may communicate with each RF reader according to one or more RF communication protocols, such as using an NFC communication protocol.

Typically, communication between reader and receiver via such an RF protocol involves the reader generating an H-field and detecting any changes in the propagation environment for this H-field. The receiver may be configured to respond to such an H-field by varying an impedance at the receiver, which in turn will manifest in a change to the propagation environment for the H-field generated by the reader, and the reader may identify this change. In other words, the receiver may be configured to change how the signal it receives from the reader is absorbed and/or reflected, and the reader may detect these changes.

If the reader is generating an H-field but not identifying any changes in its propagation environment, then the reader may infer that no receiver is present in the vicinity of the reader. The reader may then act to reduce its power consumption by varying one or more properties of the H-field it generates. For example, the reader may only intermittently generate such a field to try to identify if any receivers are present in the reader's vicinity. If a reader identifies that a receiver may be present in its vicinity, then the reader may attempt to initiate communication with that receiver according to a particular RF communication protocol (e.g. an NFC protocol). Such communication may consume more power (than the idle state for the reader), as the reader may expend more power on generating and maintaining its H-field for communicating with the receiver.

As shown in FIG. 1, the device 100 includes an antenna 10, a rectifier and splitter 30, an RF communicator 40, a controller 50 and auxiliary circuitry 60. Also shown is a coupler 20 and a switch 55.

The antenna 10 is coupled to the rectifier and splitter 30. The coupler 20 provides a connection point for connecting the antenna 10 to the rectifier and splitter 30. The rectifier and splitter 30 is coupled to each of the controller 50 and the RF communicator 40. The controller 50 is coupled to the auxiliary circuitry 60. The device 100 also includes switching circuitry for selectively electrically connecting or disconnecting components of the device 100. The switching circuitry may comprise one or more switches. As shown, the RF communicator 40 is coupled to the rectifier and splitter 30 via switch 55 of the switching circuitry. The switching circuitry may also include additional switches not shown in FIG. 1. For example, one or more electrical components of the rectifier and splitter 30 may be connected to at least one switch of the switching circuitry. The controller 50 is coupled to the switching circuitry.

The antenna 10 is arranged to inductively couple with an H-field provided by an RF reader. The antenna 10 is arranged to receive such a near field RF signal and to induce a corresponding RF electrical signal. The antenna 10 is coupled to the rectifier and splitter 30 to provide that induced RF electrical signal to the rectifier.

The rectifier is arranged to obtain DC electrical energy from the obtained RF electrical signal. This DC electrical energy may be used to power operation of certain components of the device 100, such as the controller 50 and the auxiliary circuitry 60. In other words, the antenna 10 and rectifier are configured to harvest energy from the H-field provided by the RF reader, and the device 100 is configured to use this harvested energy to power operation of one or more components of the device 100. The rectifier may be configured to continually harvest power from the H field provided by said another RF communications device (e.g. even when the RF communicator 40 is connected for communicating with said another RF device).

The controller 50 is configured to control operation of the device 100. In particular, the controller 50 is configured to selectively connect or disconnect different components of the device. That is, the controller 50 may be configured to control operation of the switching circuitry of the device 100 (e.g. as shown by the dashed lines between the controller 50 and the switch 55). The controller 50 may be configured to selectively open or close switches of the device 100 (i.e. to electrically connect or disconnect one or more components of the device 100). For instance, the controller 50 is configured to selectively enable the RF communicator 40 to operate as per a stored RF communication protocol. For this, to ‘activate’ the RF communicator 40, the controller 50 may control the switching circuitry to electrically connect the RF communicator 40 to the rectifier and splitter 30 (and thus to the antenna 10). Once activated, the RF communicator 40 may be configured to communicate with another RF device according to an RF communication protocol. To ‘deactivate’ the RF communicator 40, the controller 50 may control the switching circuitry to electrically disconnect the RF communicator 40 from the rectifier and splitter 30 (and antenna 10). Once deactivated, the RF communicator 40 will not be able to communicate with said another device. For example, as long as the RF communicator 40 remains deactivated, the device 100 may not be able to communicate with the reader according to the relevant RF communications protocol. In other words, the controller 50 is configured to selectively enable the device 100 to communicate with, and transmit information to, a reader according to an RF communication protocol.

The RF communicator 40, when activated, is configured to communicate with the reader according to an RF communication protocol. The RF communicator 40 comprises stored instructions for operating according to one or more different RF communication protocols (e.g. according to an NFC protocol). For this, the RF communicator 40 is configured to selectively vary an impedance of the device 100, e.g. so that fluctuations in impedance of the device 100 are detectable by an RF reader with which the device 100 is communicating. The RF communicator 40 may be selectively connected to the rectifier and splitter 30 (and thus to the antenna 10) for varying an impedance thereof. The impedance variation may be performed according to the stored RF communication protocol for transmitting relevant information between the device 100 and the reader. The RF communicator 40 may comprise an integrated circuit (i.e. an RF communicator chip) for controlling RF communications.

The auxiliary circuitry 60 is configured to obtain auxiliary data. The obtained auxiliary data may be used (e.g. by the controller 50) when determining how to control operation of the device 100. In particular, the auxiliary data may be used as part of a security/authorisation process for the device 100. The auxiliary circuitry 60 may be configured to obtain auxiliary data for a user interacting with the device 100. The controller 50 may be configured to control operation of the device 100 based on such obtained data. The auxiliary circuitry 60 may include authentication circuitry configured to obtain data based on which it may be identified whether or not the user interacting with the device 100 is an authorised user. The auxiliary circuitry 60 may comprise a sensor, such as a biometric sensor. For example, the sensor may be a fingerprint sensor configured for obtaining fingerprint data for the user interacting with the device 100 (i.e. with their finger on the sensor). The auxiliary circuitry 60 (optionally in combination with the controller 50) may be configured to determine whether or not the user of the device 100 is an authorised user by comparing the obtained auxiliary data to reference auxiliary data for one or more authorised users of the device 100. For example, if the obtained fingerprint data corresponds to reference fingerprint data for an authorised user of the device 100, it may be determined that the user is an authorised user.

The controller 50 is configured to control operation of the device 100 based on the obtained auxiliary data. In particular, the controller 50 is configured to inhibit secure information being transmitted to the reader (e.g. according to a stored RF communication protocol) unless the obtained auxiliary data indicates that this information should be transmitted. For instance, the RF communicator 40 may have stored data comprising secure information, and the controller 50 may be configured to inhibit such secure information from being transmitted to the reader until after the authorisation process has been completed. The controller 50 may be configured to control operation of the switching circuitry so that the RF communicator 40 is deactivated until authentication data has been obtained for the user interacting with the device 100 (and that obtained authentication data indicates that said user is an authorised user). In the event that the user is authorised, the controller 50 is configured to control the switching circuitry to connect the RF communicator 40 to the rectifier and splitter 30 for controlling communication with the reader according to a stored RF communications protocol. In other words, the controller 50 is configured to switch operation of the device 100 into an RF communications mode in response to determining that the obtained auxiliary data satisfies a selected criterion (i.e. the user interacting with the device 100 is an authorised user). In the RF communications mode, the RF communicator 40 may be operable to transmit said secure information to the reader (assuming the reader follows the relevant RF communication protocol for this).

In the event that the controller 50 determines that the selected criterion is not satisfied (e.g. the user interacting with the sensor is not an authorised user), the controller 50 may inhibit communication between the device 100 and the reader. For example, the controller 50 may keep the RF communicator 40 disconnected from the antenna 10 so that secure information stored in the RF communicator is not transmitted to the reader. The controller 50 may also end operation within the spoofing mode, e.g. to cause the device 100 to return to an idle mode in which it is no longer interacting with the reader.

As described above, once the auxiliary data has been obtained and the controller 50 has determined that the auxiliary data satisfies a threshold criterion, the controller 50 is configured to control the device 100 to operate in an RF communications mode in which the RF communicator 40 is activated for communicating with the reader according to an RF communications protocol. The RF communicator 40 may then commence communication with the reader according to a stored RF communications protocol, and this communication may comprise transmitting secure information from the RF communicator 40 to the reader. To switch into the RF communications mode, the controller 50 may be configured to control operation of the switch 55 and/or of one or more components of the rectifier and splitter 30 (as shown by the dashed lines in FIG. 1).

Prior to this RF communications mode being initiated, the controller 50 is configured to control the device 100 to operate in a spoofing mode. When operating in the spoofing mode, the device 100 interacts with the reader in order to cause the reader to maintain its H-field. During this time, the RF communicator 40 may be deactivated. In other words, when operating in the spoofing mode, the device 100 is configured to interact with the reader in order to cause the reader to continue providing an H-field. During this period of operating in the spoofing mode, the controller 50 may be configured to inhibit the RF communicator 40 from transmitting any secure information to the reader (e.g. according to a stored RF communication protocol), or the controller 50 may be configured to permit the RF communicator 40 only to communicate for short periods of time which are insufficient for the reader to obtain all of the relevant secure information from the RF communicator 40.

The controller 50 is configured to control the device 100 to operate in the spoofing mode so that energy harvested from the H field generated by the reader is used to power the auxiliary circuitry 60 (e.g. to power the authentication sensor). When operating in the spoofing mode, the rectifier is arranged to (e.g. continuously) harvest power from the reader H field. The controller 50 will only switch the device 100 into the RF communications mode after the device 100 has harvested a sufficient amount of energy from the H field so that authentication data is obtained for the user (and that user is an authorised user). In the RF communications mode, the rectifier may be arranged to continue (e.g. continuously) harvesting power from the reader H field. Until the relevant authentication data has been obtained, the controller 50 is configured to control the device 100 to operate in the spoofing mode (i.e. to interact with the reader so as to cause the reader to maintain its H field without transmitting information to the reader according to an RF communication protocol).

When operating in the spoofing mode, the device 100 is controlled so as to ‘spoof’ the reader into thinking that the device 100 is an RF communications device 100 looking to communicate with that reader. The device 100 may be configured to only initiate any ‘meaningful’ communication (i.e. any transfer of secure information from the RF communicator 40 of the device 100 to the reader according to an RF communication protocol) after the user of the device 100 has been authorised. Until then, the device 100 may be controlled to operate so as to engage the reader, but not to transmit such secure information to the reader.

As described above, an RF reader will detect changes in the propagation environment to the H field it generates. The device 100 is configured so that, when operating in the spoofing mode, the device 100 will provide at least one change to the propagation environment of the H field generated by the reader. In other words, the device 100 may be configured to operate so that the reader detects the presence of the device 100 in its vicinity. As one example, the RF reader will be sensitive to fluctuations in impedance of an RF receiving device 100 in the vicinity of that reader. As another example, the RF reader will be sensitive to an RF receiving device 100 actively transmitting an RF signal in the vicinity of the reader. When operating in the spoofing mode, the device 100 may be controlled to provide one or more changes in impedance thereof, to actively transmit an RF signal, and/or to mimic operation of an RF signal being actively transmitted. For example, the controller 50 may be configured to control operation of the switching circuitry to selectively connect one or more components of the device 100 to (or disconnect from) the antenna 10. The controller 50 may selectively connect/disconnect at least one component of the device 100 so as to provide a corresponding change to the propagation environment of the H field generated by the reader.

The controller 50 is configured to control the device 100 to operate in the spoofing mode until it determines that the user of the device 100 is an authorised user. During this time, the controller 50 may be configured to control the device 100 to perform a plurality of actions to continue spoofing the reader into maintaining the H-field it generates. For example, the controller 50 may control the device 100 to perform a series of actions (e.g. to repeat the same action) so as to cause the reader to continue maintaining its H field. The controller 50 may be configured to continue operating the device 100 in a spoofing mode until authorisation is complete. Once authorisation is complete, the controller 50 may control the device 100 to switch into the RF communications mode, at which point the spoofing actions may be stopped, and the RF communicator 40 may communicate with the reader according to the RF communication protocol. The controller 50 may be configured to control operation in the spoofing mode to inhibit secure information being communicated from the RF communicator 40 to the reader. The controller 50 may control operation of the device to communicate ‘spoof’ information (e.g. null information) to the reader, where that spoof information causes the reader to continue trying to communicate with the device 100 (and thus continue generating the H field) but where that spoof information does not enable the reader to gain access to secure information stored in the RF communicator 40.

In operation, the device 100 (the receiver) is moved to within the vicinity of another near field RF communications device (the reader). The rectifier and splitter 30 then begins to obtain DC electrical energy from the RF electrical signals induced by the antenna 10 when in the H field generated by the reader. Some of this obtained energy is used for powering the auxiliary circuitry 60 (e.g. an authentication sensor) so that the circuitry (the sensor) may obtain auxiliary data (e.g. authentication data for a user interacting with the sensor). While this is happening (and the auxiliary data is being obtained), the device 100 also operates in a spoofing mode in which the device 100 causes the reader to repeatedly detect the presence of the device 100 in the vicinity of the reader and to cause that reader to continue generating the H-field (which is being used to power the auxiliary circuitry 60). That is, the device 100 is operated to cause the reader to keep trying to communicate with that device 100 (and thus keep generating its H field). When in the spoofing mode, the device 100 may use some of the energy being harvested by the rectifier to power operation of one or more components of the device 100. For example, the controller 50 may use some of this power to control operation of the switching circuitry to electrically connect/disconnect one or more components of the device 100 so as to cause the reader to continue generating the H field. During this time, the device 100 may occasionally perform a spoofing action so as to cause the reader to continue providing the H field (and thus continue powering the authentication sensor).

Once the authentication sensor has obtained authentication data for the user, it is determined if the user interacting with the sensor is an authorised user. If they are not an authorised user, the process ends, but if they are an authorised user, then the device 100 is switched into an RF communications mode. In this mode, the RF communicator 40 is connected to the antenna 10 so that it may control the device 100 to communicate with the reader according to an RF communication protocol. The RF communicator 40 then performs the RF communication as per the relevant communication protocol (e.g. an NFC protocol). As one example, this arrangement may enable contactless payment to be performed only after a fingerprint of the user is verified to be a fingerprint of the authorised user of that card. As such, the device 100 may be configured to inhibit secure financial information from being transmitted to the reader (e.g. using the RF communicator 40) until after the controller 50 has established that a user of the card is an authorised user.

When in the spoofing mode, the device 100 operates so as to cause the reader to keep generating its H field (i.e. to maintain or increase the H-field). For this, the device 100 may selectively electrically connect (or disconnect) one or more components of the device 100 to the antenna 10. In so doing, the device 100 may be operated to provide fluctuations in impedance thereof. Such impedance fluctuations may ‘spoof’ the reader into thinking that it is communicating with a receiver (as per an RF communication protocol in which the receiver is configured to respond to signals transmitted by the reader). This will cause the reader to continue generating its H field as per such an RF communication protocol. Additionally, or alternatively, the device 100 may be operated to spoof the reader into thinking that the device 100 is actively transmitting an EM signal to the reader (as per an RF communication protocol in which the receiver is configured to actively generate and transmit signals itself for the reader to detect). This will also cause the reader to continue generating its H field as per such an RF communication protocol.

The device 100 may be configured to detect whether or not the reader is still maintaining its H field. For example, the device 100 may be configured to detect the presence (or absence) of such an H field. The device 100 may operate so as to monitor whether or not the H field is being generated by the reader. For example, in the event that the device 100 detects that the H field is no longer present, the device 100 may perform a further spoofing action to cause the reader to re-increase its H field. Additionally, or alternatively, the device 100 may be configured to repetitively performing such a spoofing action (e.g. to perform a series of subsequent spoofing actions) so as to keep spoofing the reader into generating the H field.

It will be appreciated in the context of the present disclosure, that the device 100 may be operated in a number of different ways to provide this spoofing functionality. For instance, the device 100 may be controlled (e.g. by the controller 50) to open/close one or more switches to give rise to a change in the operating conditions of the device 100 which is detectable by the reader. The change in operating conditions may comprise varying an impedance of the device 100 and/or it may comprise using the antenna 10 to transmit one or more EM signals.

Examples of different arrangements for providing this functionality will now be described with reference to FIGS. 2 to 8.

FIG. 2 shows example circuitry for a portion of the device 100 of FIG. 1. FIG. 2 shows the antenna 10, the coupler 20 and the RF communicator 40. The rectifier and power splitter is shown in more detail. This includes an antenna input impedance matching network 300. The rectifier and power splitter also includes a rectifying element 34 and a primary inductor 35. The rectifier may also include an output capacitor 36. An output for the harvested power is shown in FIG. 2 as load 37, which may be a component which will use and/or condition this obtained power. For instance, the load 37 shown in FIG. 2 may comprise a power conditioning system and/or the load 37 may comprise the controller 50 (e.g. which will use the obtained power). The device 100 also includes a secondary inductor 45 and a secondary capacitor 41.

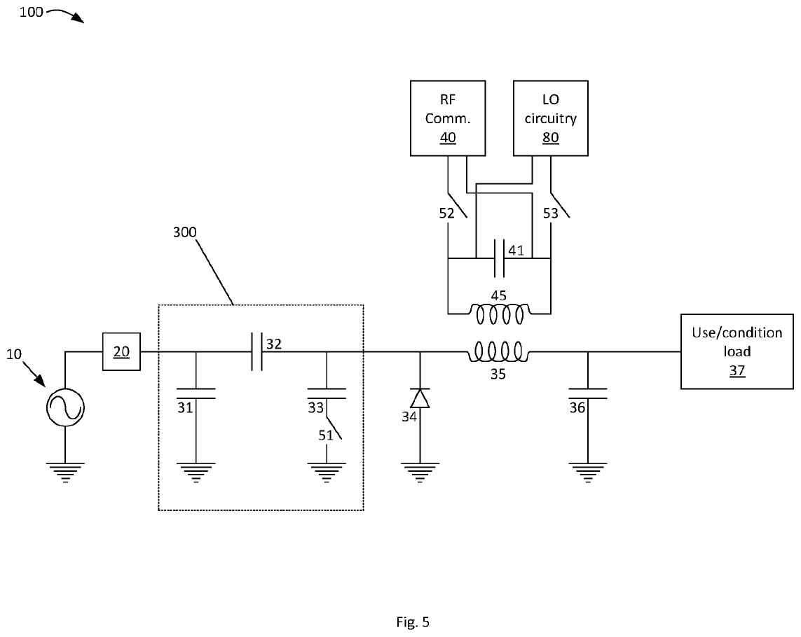

As with the device 100 of FIG. 1, the coupler 20 is arranged for coupling the rectifier and splitter 30 to the antenna 10. The rectifier and splitter 30 is arranged to receive RF electrical signals from the antenna 10, and to use these to obtain DC energy. It will be appreciated in the context of the present disclosure that a particular arrangement for the antenna input impedance matching network 300 should not be considered limiting. For example, this network 300 may be provided by a variety of topologies and components (e.g. resistors, inductors, capacitors etc.). On example is shown in FIG. 5 using capacitors, but other arrangements could be provided. The antenna input impedance matching network 300 for the device 100 is configured to match the impedance of the rectifier and splitter 30 to that of the antenna 10.

The rectifier of the rectifier and splitter 30 may include the matching network 300, or that may be provided before the rectifier. For the components shown in FIG. 2, the rectifier is provided by the rectifying element 34, as well as the primary inductor 35. The splitting functionality for the rectifier and splitter 30 is provided by the primary inductor 35 and the secondary inductor 45. The rectifying element 34 may comprise a diode, such as a Schottky diode.

The matching network 300 of FIG. 2 is connected in series with the coupler 20. One or more components within this matching network 300 may be connected between a reference voltage connection and the coupler 20. The rectifying element 34 is connected in a shunt configuration to the coupler 20. The rectifying element 34 may be connected to the coupler via one or more components of the matching network 300. The rectifying element 34 is arranged to provide a one-way conduction path between the coupler 20 (e.g. via one or more components of the impedance matching network) and the reference voltage connection, such as a ground e.g. a virtual ground. For example, a series connection of the rectifying element 34 and a component of the matching network 300 may be connected in parallel with another component of the matching network 300. The primary inductor 35 is connected, at a first end, to the connection between the rectifying element 34 and the matching network 300 and, at a second end, to an output of the rectifier. As shown in FIG. 2, the second end of the primary inductor 35 is connected to the load 37 (e.g. which may provide power conditioning and/or which may utilise the output power from the rectifier). Optionally, the device 100 may also include the output capacitor 36, which is connected between a reference voltage connection and the second end of the primary inductor 35. The series connection of the output capacitor 36 and the second end of the primary inductor 35 is connected to the voltage load 37.

To split the RF electrical signal, the secondary inductor 45 is arranged for inductive coupling with the primary inductor 35. The secondary inductor 45 may be coupled to the RF communicator 40 by a switching arrangement (although not shown in FIG. 2). Such a switching arrangement may comprise one or more RF switches, as well as one or more matching elements which connect the RF switch to the secondary inductor 45 and to the RF communicator 40. As illustrated, secondary capacitor 41 may be connected in parallel with the secondary inductor 45. Both the secondary inductor 45 and the secondary capacitor 41 are connected to the RF communicator 40 (to both terminals of the RF communicator 40).

The primary inductor 35 and secondary inductor 45 are mutually spatially arranged so that when the RF electrical signal flows in the primary inductor 35 it induces a second alternating RF signal in the secondary inductor 45. The inductive coupling between the two inductors provides an RF conduction path between the RF communicator 40 and the smartcard antenna 10 thereby to enable the RF communicator 40 to perform near field RF communications via the antenna 10 (when electrically connected thereto). The primary inductor 35 and the secondary inductor 45 may comprise laminar structures, for example tracks of conductive material carried on the substrate, such as printed coil inductors, or it may comprise stacked windings of conductors.

The switching arrangement may be coupled to the secondary inductor 45 and may be selectively operable to disable said provision of the RF electrical signal to the chip, thereby to inhibit the chip from performing near field RF communications. For example, the controller 50 may be coupled to said switching arrangement to selectively electrically connect (or disconnect) the RF communicator 40 to the antenna 10.

The output of the rectifier is connected to the load 37. The load 37 may comprise a power conditioning system. The power conditioning system may be provided between the rectifier and the components of the device to be powered by the power harvested using the rectifier (such as the controller 50 and/or the auxiliary circuitry 60). In the particular rectifier and splitter 30 shown in FIG. 2, the splitter is provided by the coupling between the primary inductor 35, which may provide part of the rectifier, and the secondary inductor 45.

It is to be appreciated in the context of the present disclosure that switching circuitry described herein for selectively connecting the RF communicator 40 to the antenna 10 could be implemented in a variety of different topologies. As one example, an RF switch may be coupled to provide a controllable short circuit between the RF terminals of the RF communicator 40. The RF switch may have a first main connection having two terminals each of which are coupled to a corresponding one the RF terminals of the RF communicator 40. The RF switch may also have a second main connection having two terminals each of which may be coupled to a corresponding one of the two ends of the secondary inductor 45. The RF switch may be selectively controllable to switch between: (i) a first state in which an RF electrical signal provided to the first main connection of the switch is conducted to the second main connection, and (ii) a second state in which the second main connection is decoupled from an RF electrical signal provided to the first main connection. In operation, the RF switch may be held in the second state to prevent an RF electrical signal from being provided to the terminals of the chip. The RF switch then be operated to change into its first state to permit the RF communicator 40 access to the antenna 10 (e.g. for communication with another said RF communications device according to an RF communication protocol).

Examples of appropriate RF switch arrangements are also described in the Applicant's co-pending application GB2017273.0, the entire contents of which are hereby incorporated by reference. Examples of near field RF communicators are defined in various standards for example ISO/IEC 18092 and ISO/IEC 21481 for NFC communicators, and ISO/IEC 14443 and ISO/IEC 15693 for near field RF communicators.

The circuitry shown in FIG. 2 may therefore enable DC energy to be harvested from the H field generated by a reader, as well as to enable an RF communicator 40 to be selectively activated for RF communication with the reader. However, it will be appreciated in the context of the present disclosure that the particular circuitry shown should not be considered limiting, and that other arrangements for e.g. the rectifier and splitter 30 could be provided.

As described above, the device 100 may be configured to operate in the spoofing mode by varying impedance so as to cause the reader to continue generating its H field. Although no switches are shown in FIG. 2, it is to be appreciated that switching circuitry of the device 100 may include one or more switches for selectively electrically connecting/disconnecting components of the device 100 to give rise to impedance variations thereof. For example, one or more components of the matching network 300 may be coupled to a switch. Such a switch may be provided between that component of the matching network 300 and the reference voltage connection. For example, where the matching network 300 includes a capacitor, that capacitor may be coupled to such a switch, e.g. between the capacitor and the reference voltage connection. Similarly, a switch may be provided between the output capacitor 36 and the reference voltage connection. Likewise, the secondary inductor 45 and/or secondary capacitor 41 may be connected to a switch. Similarly, a switch may be provided for controlling DC load variation (e.g. for varying the voltage seen at the rectifier output). Opening/closing of such switches may cause impedance variations which may be detected by the reader (and which may thus cause the reader to continue generating the H field).

The device 100 may comprise at least one component (e.g. a switch) which may be operated for varying impedance. The component may be located upstream or downstream of the rectifying element 34 (i.e. either before, ‘upstream’, or after, ‘downstream’, the output from the rectifying element 34 when moving from the antenna 10 towards the load). For downstream impedance changes, the device 100 may provide DC load variation and/or impedance variation on the terminals of the secondary coil. For upstream impedance changes, a switch may be connected between a component of the matching network, such as an input capacitor (e.g. first reference capacitor 31 or second reference capacitor 33, as will be described later in relation to FIG. 5) and its reference voltage connection. Additionally, or alternatively, the splitter (i.e. the primary inductor 35 and the secondary inductor 45) may be moved upstream of the rectifying element 34. In which case, impedance modulation applied to, e.g. the two ends of the secondary inductor 45, may be provided upstream of the rectifying element 34. As such, the electrical signals received from the antenna 10 may travel through the primary inductor 35 (and thus secondary inductor 45) before they reach the rectifying element 34.

In other words, the rectifier and splitter 30 may provide a number of different components which could be operated for providing impedance variations thereof. The controller 50 may be configured to control operation of the device 100 to operate so as to provide such impedance changes. For example, the controller 50 may be configured to control operation of one or more switches of switching circuitry of the device 100 to cause impedance changes to occur.

In examples where the changes in impedance are applied upstream of the output of the rectifying element 34 (e.g. between the antenna 10 and the rectifying element 34), the changes in impedance may be of larger magnitude. Such larger magnitude impedance changes may be more detectable to the reader. In particular, by spoofing the reader with such larger impedance changes, the reader may interpret this as a new receiver being identified/present in the vicinity of that reader. For example, larger changes in impedance may mimic the action of a user removing their device 100 (e.g. smartcard) from being close to the reader, and then placing their device 100 back near to the reader again. That is, by operating the device 100 to provide a larger impedance swing (as detected by the reader), the reader may respond by re-initiating communication according to its RF communication protocol. As such, the reader may continue to generate its H field to try to communicate with the receiver it thinks it has identified as just having come to its vicinity. As one example, the device 100 may be configured to vary the impedance at an input impedance matching network (e.g. by operating a switch coupled to one or more components, such as input capacitors, for the device 100).

By operating the device 100 to provide impedance changes which are detectable by the reader (and especially when those impedance changes are applied upstream of the rectifying element 34 output), the device 100 may spoof the reader into maintaining its H field for a longer period of time than it might otherwise have done so. This is because the device 100 operates to spoof the reader into thinking that it needs to keep generating its H field for communicating with a receiver in its vicinity (as per its RF communication protocol). During this spoofing time period, the device 100 may not have transmitted any secure information to the reader (e.g. as per a particular RF communication protocol), as the RF communicator 40 may have been deactivated (e.g. by the controller 50). However, by providing such impedance fluctuations, the device 100 will have spoofed the reader into maintaining its H field, and thus permitting the device 100 to harvest energy therefrom to operate the auxiliary circuitry 60. Then, once the relevant auxiliary data criterion has been satisfied, the device 100 may activate the RF communicator 40 for engaging with the reader. The reader will then control its H field according to the relevant RF communication protocol with which it communicates with the RF communicator 40 of the device 100. During this RF communication period, the device 100 may still harvest power from the reader (such as for powering operation of the controller 50 and/or RF communicator). Once this process is complete (i.e. once both the spoofing operation and the RF operation have finished), the device 100 may no longer communicate with the reader, i.e. the device 100 may cease to operate in its spoofing mode or its RF communications mode. The reader may then revert to a lower power mode in which it does not maintain its H field generation to the same extent.

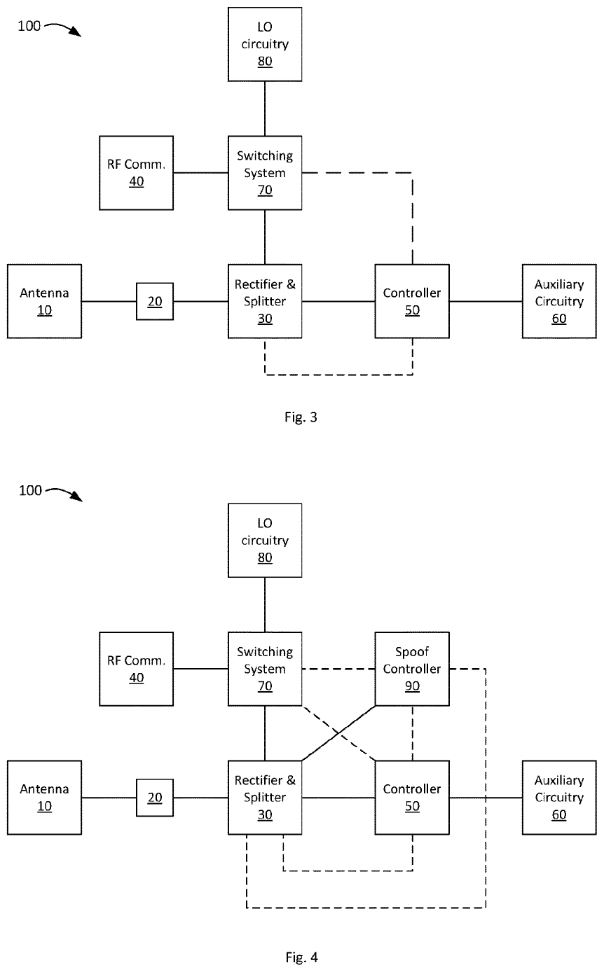

As described above, the device 100 may operate one or more components of the rectifier and splitter 30 to impart impedance changes to cause the device 100 to operate in the spoofing mode (prior to operation in an RF communications mode). For example, the controller 50 may be configured to control operation of one or more such components to provide the changes in impedance (e.g. by controlling operation of switching circuitry of the device 100). Example devices in which additional components are included for providing such spoofing functionality will now be described with reference to FIGS. 3 to 7.

FIG. 3 shows a device 100. The device 100 of FIG. 3 is similar to that of FIG. 1 in that it includes the antenna 10, the coupler 20, the rectifier and splitter 30, the RF communicator 40, the controller 50, and the auxiliary circuitry 60. The description above of these components also applies here, and so shall not be repeated. Additionally, the device 100 of FIG. 3 includes a switching system 70 and local oscillator (‘LO’) circuitry 80.

The switching system 70 is coupled to each of the RF communicator 40 and the LO circuitry 80. The switching system 70 is operable to selectively couple one (or neither) of the RF communicator 40 and the LO circuitry 80 to the rectifier and splitter 30. The controller 50 is coupled to the switching system 70. The controller 50 is configured to control operation of the switching system 70 to select which one (or neither one) of the RF communicator 40 and the LO circuitry 80 is connected to the rectifier and splitter 30.

The LO circuitry 80 comprises a local oscillator. The LO circuitry 80 is operable to actively generate RF signals. When the LO circuitry 80 is connected to the antenna 10, the device 100 is configured to actively transmit RF signals from the antenna 10 (as generated using the LO circuitry 80). Although not shown in FIG. 3, the LO circuitry 80 may be coupled to the rectifier for receiving power therefrom (which may be used to generate the RF signals). The LO circuitry 80 may be configured to generate signals having a frequency in a frequency band selected based on an RF communication protocol. In particular, the RF communicator 40 may be configured to communicate with devices according to one or more NFC communication protocols. Corresponding readers which also communicate according to such NFC communication protocols are configured to expect communication in certain frequency bands (e.g. at or close to certain frequencies). The LO may be configured to provide signals in such frequency bands, e.g. the LO may be configured to provide a frequency in the range of 12 to 14 MHz, and/or the load modulation may be provided at a frequency around 847.5 kHz.

In other words, the device 100 may be configured to actively generate and transmit RF EM signals using the LO circuitry 80 and the antenna 10. The device 100 may be configured to respond to a detected H field from another RF communications device (e.g. a reader) by transmitting its own RF signals (e.g. back towards the reader). The response signal transmitted from the device 100 to the reader may be in an NFC frequency band. For example, in response to the H field generated by the reader, the device 100 may be configured to harvest enough power therefrom to power operation of the LO circuitry 80 so that the device 100 may respond to the H field from the reader by transmitting its own RF signal back to the reader.

The device 100 may be configured to operate in the spoofing mode by transmitting such RF signals to the reader. The device 100 may be configured to transmit such an RF signal for a first time period, before then stopping any further transmission of signals. Such operation of the LO circuitry 80 may spoof the reader into thinking that an active RF device 100 (e.g. an active NFC tag) is present and looking to communicate with the reader. In turn, this will cause the reader to continue generating its H field for communication with the device 100. The reader may continue to generate its H field for some time after it first receives the RF signal transmitted by the device 100 (and also after the device 100 stops transmitting that RF signal).

As described above, the device 100 is configured to harvest power from the H field generated by the reader to power the auxiliary circuitry 60. For this, the device 100 is configured to operate in the spoofing mode to cause the reader to continue generating the H field, and the device 100 is configured to obtain power from that H field. The device 100 will continue to operate in the spoofing mode until auxiliary data has been obtained, and it is determined if that auxiliary data satisfies a threshold criterion.

For the device 100 of FIG. 3, the controller 50 is configured to control the switching system 70 to switch between different modes of operation. To operate in the spoofing mode, the LO circuitry 80 is connected to the rectifier and splitter 30, and to operate in the RF communications mode, the RF communicator 40 is connected to the rectifier and splitter 30. The switching system 70 may be operated to inhibit the RF communicator 40 being connected to the rectifier and splitter 30 until the auxiliary data has been obtained (and that auxiliary data satisfies a threshold criterion). During this time, the device 100 may operate in the spoofing mode so that more power can be obtained from an H field generated by the reader. For this, the switching system 70 may be operated to connect the LO circuitry 80 to the rectifier and splitter 30. The switching system 70 may keep the LO circuitry 80 connected to the rectifier and splitter 30 throughout the time period in which the device 100 operates in the spoofing mode, or the LO circuitry 80 may only be connected for some of that time. For example, the switching circuitry may be operated so that the LO circuitry 80 is initially connected for transmitting the RF signal, and then the LO circuitry 80 may be disconnected (e.g. once the transmitted signal has caused the reader to respond by maintaining its H field). At which point, neither the RF communicator 40, nor the LO circuitry 80, may be connected to the rectifier and splitter 30, and the device 100 may instead be powering operation of the auxiliary circuitry 60.

The device 100 may be configured to control operation of the switching system 70 to utilise the LO circuitry 80 to operate the device 100 in the spoofing mode (i.e. to connect the LO circuitry 80 to the rectifier and splitter 30, and thus antenna 10). With the device 100 operating in the spoofing mode, the auxiliary data is obtained, and if this auxiliary data satisfies the threshold criterion, the device 100 is configured to control operation of the switching system 70 to utilise the RF communicator 40 for communicating with the reader (i.e. to connect the RF communicator 40 to the rectifier and splitter 30, and thus antenna 10).

Optionally, the device 100 may be configured to phase match the RF signals it transmits with a phase of the H field generated by the reader. That is, the device 100 may be configured to generate and transmit RF signals having a controlled phase difference relative to those generated by the reader. For example, the device 100 may include circuitry configured to generate a clocking signal obtained from a carrier signal provided by the reader. The clocking signal may be used to control operational timings of the device 100. For example, operation of the switching system 70 may be controlled according to the clocking signal, e.g. so that timings for the signals generated and transmitted by the device 100 are controlled according to the clocking signals. As one example, circuitry for phase matching the RF signals transmitted by the device 100 with those received from the reader may include an inverter-based clock generator followed by a frequency divider.

As described above with reference to FIGS. 1 and 2, the controller 50 may be configured to control operation of the rectifier and splitter 30 to operate the device 100 in the spoofing mode. For example, the controller 50 may be configured to control operation of switching circuitry (e.g. to open/close at least one switch) to provide impedance changes to spoof the reader into maintaining its H field. This same functionality may be provided by the controller 50 in the device 100 of FIG. 3. The device 100 of FIG. 3 may be configured to utilise both the LO circuitry 80 and this control of one or more components of the rectifier and splitter 30 to operate in the spoofing mode. The two may be used together (e.g. simultaneously), or they may be used sequentially. Both options may be used for spoof the reader into maintaining its H field.

As one example, the device 100 may be configured to initially use the LO circuitry 80 in the spoofing mode, before then varying impedance at the rectifier and splitter 30 (still in the spoofing mode), before then switching to the RF communications mode. For this, the device 100 may initially control operation of the switching system 70 so that the LO circuitry 80 is connected to the rectifier and splitter 30 (and thus antenna 10). The device 100 will then transmit an RF signal to the reader, before stopping this transmission (by operating the switching system 70 to disconnect the LO circuitry 80 from the rectifier and splitter 30). While still in the spoofing mode, the device 100 may harvest enough power from the reader's H field to obtain the auxiliary data, and to determine that the auxiliary data satisfies the threshold criterion. In response to this determination, the device 100 may be controlled so as to vary an impedance thereof (e.g. by operating switching circuitry of the device 100, such as to vary an impedance associated with one or more components of the rectifier and splitter 30). For example, the controller 50 may open/close at least one switch in the circuitry which provides the rectifier and splitter 30, thereby to connect/disconnect at least one component to/from the antenna 10 (and thus cause a change in impedance to be detected by the reader).

After this, the device 100 may then switch to operate in the RF communications mode. For example, the controller 50 may control operation of the switching system 70 to connect the RF communicator 40 to the rectifier and splitter 30 (and thus the antenna 10). As described above in relation to FIGS. 1 and 2, the reader may detect the change in impedance of the device 100, and in response, it may restart attempting to communicate according to its RF communication protocol. At which point, the RF communicator 40 will be connected to the antenna 10, and so may respond to the subsequent communication from the reader according to the relevant RF communication protocol.

In other words, the device 100 may be configured to operate in the spoofing mode to cause the reader to maintain the H field it generates, before operating to cause the reader to restart communication according to the relevant RF communication protocol. Once the reader reinitiates its communication attempts according to this communication protocol, the device 100 is configured to respond according to that RF communication protocol (i.e. with the RF communicator 40 connected to the antenna 10).

An example RF communications device 100 will now be described with reference to FIG. 4.

FIG. 4 shows a device 100 which is very similar to that of FIG. 3. Components of the device 100 of FIG. 3 which have previously been described will not be described again here. The device 100 of FIG. 4 differs from that of FIG. 3 in that the device 100 also includes a second controller, shown as ‘spoof’ controller 90.

The spoof controller 90 is connected to the rectifier and splitter 30. The spoof controller 90 is arranged to receive power harvested from the rectifier. The spoof controller 90 may be configured to control operation of the switching system 70 and/or the rectifier and splitter 30. The controller 50 and spoof controller 90 may be coupled to each other for transmitting signals therebetween.

The function and operation of the device 100 of FIG. 4 is essentially the same as that described above in relation to FIG. 3. However, some of the controlling of the device 100 may be performed instead by the spoof controller 90 (e.g. as compared to being performed by the controller 50). In particular, the spoof controller 90 may be configured to control operation of the device 100 in the spoofing mode. The spoof controller 90 may be a low power controller. For example, the spoof controller 90 may be provided by a lower power processor than the controller 50, e.g. an ultra-low-power microprocessor could be used to provide the spoof controller 90, or the spoof controller 90 could be implemented using fixed logic such as comparators and switching devices. The spoof controller 90 may reduce the power consumption required for the device 100 to operate in the spoofing mode, as compared to using the controller 50 (which has additional functionality such as being able to interact with the auxiliary circuitry 60) to control this same operation.

The spoof controller 90 may be configured to control the operation of the device 100 in the spoofing mode to cause the reader to maintain its H field. For this, and as described above, the spoof controller 90 may be configured to control operation of the switching system 70 and/or the rectifier and splitter 30. This control may comprise controlling operation of the device 100 to provide one or more changes in impedance to be detected by the reader and/or selectively connecting the LO circuitry 80 to the oscillator for the device 100 to transmit and RF signal to the reader. The controller 50 may be configured to at least partially control operation of the spoof controller 90. For example, the controller 50 may operate to cause the spoof controller 90 to initiate its control (e.g. to start operation of the device 100 in the spoofing mode). The controller 50 may cause the spoof controller 90 to stop controlling the device 100 once auxiliary data satisfying the threshold has been obtained (and at which point the controller 50 may take over control to cause the RF communicator 40 to start communicating with the reader), and/or at that stage the controller 50 may instruct the spoof controller 90 to control the switching system 70 to connect the RF communicator 40 to the antenna 10 for communicating with the reader.

It is to be appreciated in the context of the present disclosure that the spoof controller 90 does not need to be provided with all of the components shown in FIG. 4. For example, the spoof controller 90 could be included in the device 100 of FIG. 1 for controlling operation of the device 100 in the spoofing mode. In which case, the spoof controller 90 could still reduce the power requirements for the device 100, while enabling the spoofing mode to occur (which may thus reduce the amount of time required for the device 100 to operate in the spoofing mode to harvest enough power for obtaining the auxiliary data).

An example RF communications device 100 will now be described with reference to FIG. 5.

FIG. 5 shows a device 100. The device 100 of FIG. 5 is similar to those described above in relation to FIGS. 1 to 4. In particular, the device 100 of FIG. 5 is very similar to a combination of the features shown in FIGS. 2 and 3. Again, components of the device 100 of FIG. 5 which have been described above will not be described again.

As compared to the device 100 of FIG. 2, the device 100 of FIG. 5 shows more components of the matching network 300, also includes LO circuitry 80 and a plurality of switches (first switch 51, second switch 52, third switch 53).

For FIG. 5, the antenna input impedance matching network 300 is formed of a plurality of capacitors: a first reference capacitor 31, series capacitor 32, and a second reference capacitor 33. The series capacitor 32 is connected in series with the coupler 20. The first reference capacitor 31 is connected between a reference voltage connection and the coupler 20. The second reference capacitor 33 is connected between a reference voltage connection and the series capacitor 32. The second reference capacitor 33 is connected to the other electrode of the series capacitor 32 to the electrode of the series capacitor 32 which is connected to first reference capacitor 31. The second reference capacitor 33 is connected between the series capacitor 32 and the rectifying element 34. In other words, a series connection between the second reference capacitor 33 and the series capacitor 32 is connected to the rectifying element 34.

The rectifying element 34 is connected in a shunt configuration to the coupler 20 via the series capacitor 32 to provide a one-way conduction path between the coupler 20 (via the series capacitor 32) and the reference voltage connection, such as a ground e.g. a virtual ground. The primary inductor 35 is connected, at a first end, to the connection between the rectifying element 34, the series capacitor 32 and the second reference capacitor 33, and, at a second end, to an output of the rectifier. As shown in FIG. 2, the second end of the primary inductor 35 is connected to the load 37.

The secondary inductor 45 and the secondary capacitor 41 are connected to both the RF communicator 40 and the LO circuitry 80. One terminal of the RF communicator 40 is connected to both a first electrode of the secondary capacitor 41 and a first end of the secondary inductor 45, and the other terminal of the RF communicator 40 is connected to a second electrode of the secondary capacitor 41 and a second end of the secondary inductor 45. One terminal of the LO circuitry 80 is coupled to the first electrode of the secondary capacitor 41 and the first end of the secondary inductor 45, and the other terminal of the LO circuitry 80 is coupled to the second electrode of the secondary capacitor 41 and the second end of the secondary inductor 45.

As described above, the device 100 may include switching circuitry for selectively connecting/disconnecting different components within the device 100. Several example switches for this circuitry are shown in FIG. 5. The first switch 51 is arranged between the second reference capacitor 33 and the reference voltage connection. The second and third switch 52, 53 may provide the switching system 70 as described above in relation to FIGS. 3 and 4. The second switch 52 is arranged between the RF communicator 40 and the secondary inductor 45 and secondary capacitor 41. The third switch 53 is arranged between the LO circuitry 80 and the secondary inductor 45 and secondary capacitor 41. For example, the second switch 52 may be arranged between the RF communicator 40 and both the first electrode of the secondary capacitor 41 and the first end of the secondary inductor 45. For example, the third switch 53 may be arranged between the LO circuitry 80 and both the second electrode of the secondary capacitor 41 and the second end of the secondary inductor 45. Although not shown, a controller of the device 100 (e.g. controller 50 or spoof controller 90) may be coupled to these switches for controlling operation thereof.

The device 100 of FIG. 5 may be configured to operate in the manner described above in relation to FIGS. 1 to 4.

The device 100 may operate initially in the spoofing mode. For this, the third switch 53 may be closed to connect the LO circuitry 80 to the antenna 10 for transmitting an RF signal to the reader. Additionally, or alternatively, operating in the spoofing mode may comprise selectively opening and/or closing the first switch 51, thereby to change an impedance of the device 100. The device 100 may operate both the first and third switch 51, 53 for the spoofing mode. For example, the device 100 may be configured to initially close the third switch 53 for the LO oscillator to cause the device 100 to transmit the RF signal, before then opening the third switch 53 to disconnect the LO circuitry 80 from the antenna 10. The device 100 may be configured to control operation of the first switch 51 (e.g. simultaneous to operation of the third switch 53 or subsequently to opening the third switch 53) to cause impedance variations to occur. The second switch 52 may then be closed (in the event that the obtained auxiliary data satisfies the threshold criterion) to cause the RF communicator 40 to connect to the antenna 10 for communicating with the reader.

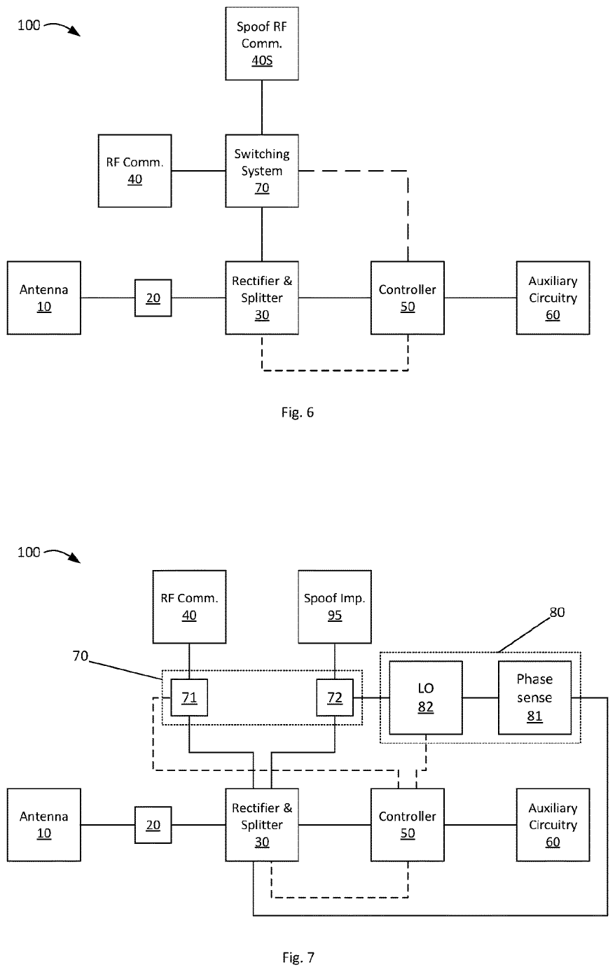

An example RF communications device will now be described with reference to FIG. 6.

The device of FIG. 6 is very similar to that of FIG. 3. The device of FIG. 6 includes a spoof RF communicator 40S and does not have the oscillator circuitry 80 of FIG. 3. The spoof RF communicator is coupled to the switching system 70 (in a similar manner to that for the oscillator circuitry 80 in FIG. 3).

The spoof RF communicator 40S comprises an RF communicator. For example, the spoof RF communicator 40S may be provided by the same component as the RF communicator 40, or another component could be used. As described above, the RF communicator 40 contains stored secure information. For example, the device may provide a bank card, and the RF communicator 40 may store secure information for performing financial transaction details. The spoof RF communicator 40s may be a similar type of component to the RF communicator 40, but it does not store such sensitive information. For instance, the spoof communicator 40S may have stored instructions for performing one or more RF communication protocols. However, the spoof RF communicator 40S is configured so that the information it communicates is not secure (or at least any information communicated by the spoof communicator 40S may effectively be null). For example, the spoof RF communicator 40S may be configured to follow a communication protocol for communicating with a reader, but that communication protocol will ultimately not result in e.g. a successful bank transaction, as the spoof RF communicator 40S does not contain the requisite secure information for this.

In other words, the spoof RF communicator 40S may be configured to communicate with a reader according to one or more RF communication protocols by transmitting null (or ‘dummy’) information to the reader. The spoof RF communicator 40S is configured to follow a communication protocol with the reader, so as to cause the reader to continue trying to communicate with the spoof communicator 40S (e.g. as per that RF protocol), and thereby to maintain its H field (from which the device 100 is configured to harvest power). As such, the device 100 may be configured to operate in the spoofing mode by activating the spoof RF communicator 40S to communicate with said reader. The spoof RF communicator 40S may be provided by an NFC chip. As will be appreciated in the context of the present disclosure, communication between the reader and the spoof RF communicator 40S may occur for a relatively long time period before the reader identifies that the spoof RF communicator 40S does not have suitable secure information to be communicated to the reader. The spoof RF communicator 40S may be provided by a component which follows a longer, more complex, and/or more uncommon RF communication protocol so as to increase the amount of time for which the reader tries to communicate with said spoof communicator 40S.

Such a spoof RF communicator 40S may be configured to communicate in a manner expected by the reader (e.g. providing relevant impedance variations according to the RF communication protocol). To operate the device in the spoofing mode, the controller 50 may be configured to activate the spoof communicator 40S (and ensure the RF communicator is deactivated) by selectively connecting the spoof communicator 40S to the antenna (e.g. using the switching system). During this time period of operating in the spoofing mode, the RF communicator 40 may be deactivated, and may thus not communicate any secure information to the reader. In other words, the reader may only be receiving dummy information as a result of it following its communication protocols. In the event that obtained auxiliary data then satisfies the threshold criterion, then the controller may switch in the RF communicator 40 (and switch out the spoof communicator 40S), so that communication between RF communicator 40 and the reader may commence (where secure information may be transmitted from the RF communicator 40 to the reader).

As described above in relation to FIG. 6, the spoof RF communicator 40S may effectively be provided by an off the shelf component (e.g. an NFC chip) which does not contain any relevant secure data. However, this should not be considered limiting, as the spoof RF communicator 40S could be provided by additional or alternative components. For instance, the spoof RF communicator 40S may instead (or additionally) comprise circuitry configured to emulate the operation of a typical (e.g. off the shelf) RF communicator. For example, such spoof RF communicator circuitry may be configured to selectively provide impedance variations. For this, the circuitry may comprise one or more switches for selectively changing impedance. The circuitry may be configured to provide changes in impedance by selectively opening or closing said switches.

Such spoof RF communication circuitry may be configured to cause impedance changes in a manner which is similar to the manner in which they are provided by an RF communicator. For example, the circuitry may be configured to provide the impedance changing according to a timing schedule similar to that associated with RF communication protocols. For example, the circuitry may operate according to a conventional oscillation frequency for such RF communication (e.g. around 847 KHz). The oscillation circuitry could use any suitable approach disclosed herein to actually implement the impedance changes. The circuitry may be configured to control the timings for these impedance changes to spoof the reader into thinking that the signals being communicated are consistent with what the reader would expect to see when communicating with an actual RF communicator. The circuitry may be configured to provide impedance changes which oscillate at approximately the relevant frequency at which the reader will expect to see impedance variations (e.g. around 847 KHz). These changes may just be a simple oscillation pattern (e.g. 1,0,1,0,1 . . . etc.) or a more complex scheme may be utilised, such as one which more closely mimics how different impedance changes may be used when following an RF communication protocol (e.g. as per a selected RF communication handshake protocol). The circuitry may also include phase matching circuitry arranged to synchronise a phase of the spoof RF communication with a corresponding phase of the RF signals generated by the reader. For example, the circuitry may be configured to provide impedance changes according to a selected timing pattern, where that timing pattern is at a frequency selected to be at or similar to an expected frequency for such impedance changes according to an RF communication protocol, and/or where that timing pattern is controlled to be phase synchronised with signals transmitted from the reader (e.g. with a selected phase offset to those signals transmitted from the reader).

It will be appreciated in the context of the present disclosure that such a spoof RF communicator 40S and/or such spoof RF communication circuitry could be utilised in any of the devices 100 disclosed herein. For example, this may be used to provide (additional) spoofing functionality for such devices of the present disclosure.

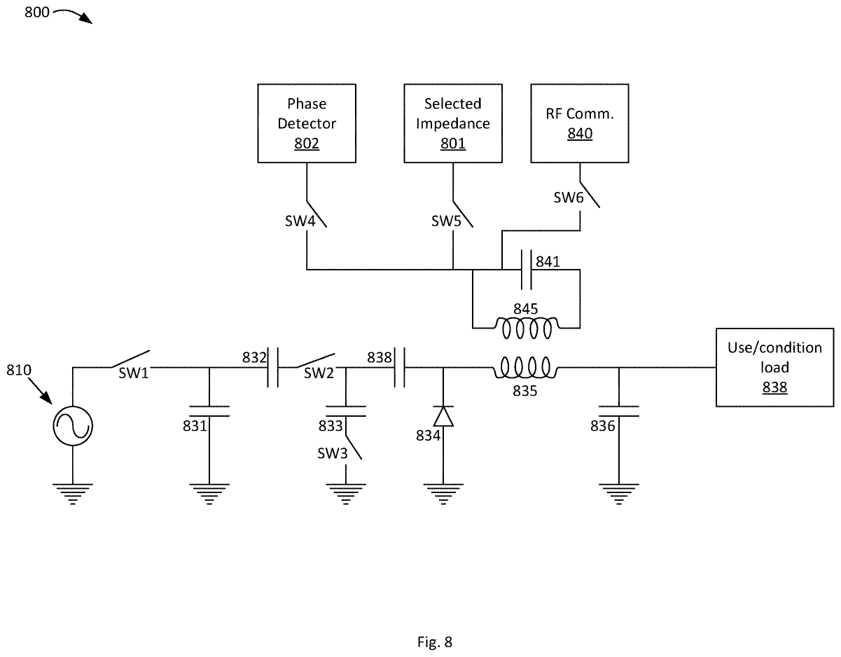

An example device 100 will now be described with reference to FIG. 7.

The RF communications device 100 of FIG. 7 is similar to that of FIG. 3. In addition, the device 100 of FIG. 7 includes a spoofing impedance changer 95. The switching system 70 is shown as including a first switch 71 and a second switch 72, and the local oscillator circuitry 80 is shown as including phase sensing circuitry 81 and a local oscillator (‘LO’) 82.

The spoofing impedance changer 95 may be provided by any suitable circuitry described herein for selectively changing the impedance of the device 100 for spoofing the reader into maintaining its H field (e.g. it could be a spoof RF communicator 40S, or one or more switchable components for implementing impedance changes).

The controller 50 is coupled to the first switch 71 for selectively activating (or deactivating) the RF communicator 40. As described herein, the controller 50 may be configured to selectively connect the RF communicator 40 to the antenna for communicating with the reader according to a stored RF communication protocol.

The device 100 of FIG. 7 differs from that of FIG. 3 in that the local oscillator circuitry 80 is arranged to selectively connect the spoof impedance changer 95 to the rectifier and splitter 30 (and thus antenna 10), rather than the local oscillator circuitry 80 itself being selectively connectable to the antenna 10. For this, the local oscillator circuitry 80 is coupled to the second switch 72. The local oscillator circuitry 80 is also coupled to the rectifier and splitter 30 for receiving signals therefrom. The phase sensing circuitry 81 is configured to sense a phase of incoming signals from the reader for phase synchronising operation of the LO 82 (e.g. so that the signals seen by the reader will be at the expected phases). The controller 50 may also be coupled to the LO circuitry 80 (e.g. to the LO 82) for controlling operation thereof. The LO 82 may be configured to selectively open or close the second switch 72 according to its oscillation frequency and the synchronised phase. In other words, the LO circuitry 80 may be configured to operate so as to selectively connect/disconnect another component of the device to the antenna, where that other component (when connected) will cause an impedance change to the device 100, e.g. so that those impedance changes are at a selected frequency (chosen by the LO 82) and/or so that they are phase synchronised (as per the operation of the phase synchronisation circuitry 81, such as to provide a controlled phase offset). Such resulting impedance changes (and their timings) may spoof the reader into thinking that this is due to a receiver trying to communicate therewith (thereby to cause the reader to continue generating its H field).

In examples described herein, operating in the spoofing mode comprises providing variations in impedance of the antenna 10. In turn, this varying antenna impedance is detected by the reader, and causes the reader to maintain or increase its H-field. Devices of the present disclosure may employ use of either a relatively large change to the antenna impedance or a relatively small change to the antenna impedance. The larger change may comprise a variation in impedance at an antenna impedance matching network. The smaller change may comprise a variation in impedance at other components of the device (e.g. which are connected to the antenna via the antenna impedance matching network). Devices of the present disclosure may be configured so that such a larger change in impedance may mimic a change in impedance similar to that associated with a new RF communicating device coming into proximity of the reader. Devices of the present disclosure may be configured so that such a smaller change in impedance may mimic a change in impedance similar to that associated with an RF communicator attempting to follow an RF communications protocol with the reader.

Both these smaller and/or larger changes in impedance may be implemented by operating one or more switches of the device.

For the larger impedance change switching, this switching may comprise a single on/off change, e.g. to provide a sudden large change in antenna impedance, or it may comprise switching at a relatively low frequency (e.g. in the order of Hz to kHz). This switching may be controlled by a controller (e.g. controller 50) of the device. Such a controller may comprise any or all of: a microcontroller, logic (e.g. discrete logic) as a time-based device (e.g. like an RC tank) and a comparator with hysteresis.

For the smaller impedance change switching, this switching may comprise multiple changes (e.g. continuous switching between on/off states). The frequency of these changes may be much higher than that for the larger impedance change switching. For example, these switching changes may be controlled to occur at a frequency similar to that associated with certain RF communication protocols, such as at a frequency at or similar to the carrier signal or a modulating signal. For this smaller impedance change switching, devices of the present disclosure may selectively connect a component operable at such frequencies to the antenna (e.g. a dedicated spoof RF communicator 40S or LO circuitry 80).

Additionally, or alternatively, devices of the present disclosure may selectively operate one or more switches, where the switch is operated at such a frequency. For example, the switch may be selectively opened/closed at a frequency in a selected frequency range (e.g. where that frequency range is selected to be at or close to a frequency range of a known RF communication protocol). In such examples, the impedance which is being selectively connected/disconnected to the antenna (e.g. by opening/closing switch according to the selected frequency range) could comprise a component having a fixed impedance, and wherein the operation of the switch(es) sets the impedance variation frequency. For example, the device may comprise a selected impedance component, e.g. a capacitor, which has an impedance value chosen for being used to selectively modulate the antenna impedance accordingly. For example, the component (e.g. capacitor) may have an impedance which is selected to be at or close to an impedance of a NFC chip (whose RF communication the impedance variation of the device is configured to mimic).

Devices of the present disclosure may include relevant circuitry to control operation of the one or more switches so that their switching frequency is in the selected frequency range. For this, the device may comprise LO circuitry comprising its own local oscillator responsible for generating such a frequency. Additionally, or alternatively, the device may comprise a component configured to obtain such a frequency from signals emitted by the reader. For instance, the device may comprise a component which is configured to obtain this frequency of oscillation from carrier signals from the reader. In this sense, the device may not actually comprise a local oscillator per se. The device may be configured to use the incoming RF signal from the reader as the source of oscillation. For example, devices of the present disclosure may comprise phase detection circuitry, such as a phase detector, an edge detector and/or a frequency divider (e.g. an in phase frequency divider). The phase detection circuitry may be configured to detect a frequency of an incoming RF signal (e.g. the frequency of the carrier wave being transmitted by the reader). Operation of the device may be controlled based on this detected frequency of the incoming RF signal. For example, such phase detection circuitry may be used instead of the LO circuitry described above and shown in FIGS. 1 to 7. The use of such phase detection circuitry may be advantageous, as firstly it may avoid the need for a separate LO, but also it may ensure that the resulting frequency signal used by the device is in phase with the corresponding RF signal from the reader.

The phase detection circuitry may comprise both a phase detector and a frequency divider. The phase detection circuitry may be configured to obtain a signal which is in phase with the carrier signal. The frequency divider may be configured to reduce a frequency of the detected incoming frequency. For example, the frequency divider may act to divide the incoming RF signal frequency by a chosen number such that the resulting (i.e. divided) frequency is with a selected frequency range, e.g. a frequency range associated with the RF communication protocol. The frequency divider may be a power of 2 divider. For example, the frequency divider may be configured to divide the incoming RF frequency multiple times until the resulting frequency is in the selected range. Once a suitable signal has been obtained, i.e. once the incoming RF signal has been detected and then optionally divided to such an extent that the resulting signal is in the selected frequency range, this resulting signal may be used to control a frequency of impedance modulation. That is, the impedance of the antenna may be modulated at the frequency of the obtained (and divided) RF signal. As described above, this impedance modulation may comprise selectively opening and closing a switch to selectively connect/disconnect an impedance to the antenna.

Another example RF communications device will now be described with reference to FIG. 8.

FIG. 8 shows a device 800 which is similar to the device 100 shown in FIG. 5. The device 800 of FIG. 8 is intended to show a plurality of different options for controllable switches which may be controlled to operate the device in a spoofing mode, as disclosed herein. However, it is to be appreciated that the number and location of these switches should not be considered limiting. Instead, the switches are just included to show different options—only one of these switches may be used, or only some, or all of them may be included.

As with FIG. 5, the device 800 of FIG. 8 may include a plurality of capacitors, which, as shown in FIG. 8 includes first and second reference capacitors 831 and 833, respectively, and first and second series capacitors 832 and 838, respectively. The device 800 also includes a rectifying element 834 (e.g. a diode), a primary inductor 835, an output capacitor 836 and a load 837. These features may be the same as those described above for FIG. 5, except with the second series capacitor 838 being connected between (i) the first series capacitor 832 and the second reference capacitor 833, and (ii) the rectifying element 834 and the primary inductor 835. The device 800 of FIG. 8 also includes a secondary inductor 845, a secondary capacitor 841, an RF communicator 840, a selected impedance 801 and a phase detector 802.

The device 800 of FIG. 8 includes a plurality of switches—shown as first to sixth switches SW1 . . . SW6. The first, second and third switches SW1, SW2, SW3 are all connected to one or more components of the antenna impedance matching network. Operating any of these switches may provide a relatively large impedance change at the antenna 810. The first switch SW1 is located between the antenna 810 and the first reference and series capacitors 831, 832. The second switch SW2 is located between (i) the first series capacitor 832 and (ii) the second reference and series capacitors 838, 833. The third switch SW3 is located between the second reference capacitor 833 and a ground connection. Any or all of these switches may be operated to provide a relatively large impedance change at the antenna 810. For example, a controller may be used to control operation of any or all of these switches. The device may be configured to switch any of these switches at a relatively low frequency (e.g. the order of Hz).

The phase detector 802 may be configured to detect a frequency of an incoming RF signal from the reader, such as the carrier signal. The phase detector 802 may comprise a frequency divider. The frequency divider may be configured to divide down a frequency of the obtained frequency from the incoming RF signal. The phase detector 802 may be associated with switch SW4 (e.g. SW4 may be used to control the operation of the phase detector 802 on the rest of the device 800). The selected impedance 801 may comprise a component having an impedance selected to be at or similar to that of an RF communications chip (e.g. an NFC chip). For example, the selected impedance 801 may comprise a capacitor. The selected impedance may be associated with switch SW5. Switch SW5 may be arranged to selectively connect/disconnect the selected impedance 801 to the antenna 810. The RF communicator may be associated with switch SW6. Switch SW6 may be arranged to selectively connect/disconnect the RF communicator 840 to the antenna 810.

The device 800 may be configured to only operate switch SW6 to connect the RF communicator 840 to the antenna 810 in the event that correct authentication has been obtained. Before then, the device 800 may be configured to control operation of one or more of the remaining switches for operating in the spoofing mode. For example, any of switches SW1, SW2 or SW3 may be selectively opened/closed to provide relatively large impedance changes at the antenna 810. Additionally, or alternatively, switches SW4 and SW5 may be controlled to provide smaller impedance changes at the antenna 810. In particular, switch SW4 may be operated to allow the phase detector 802 to control the connection between the impedance 801 and the antenna 810. For instance, the switch SW4 may be closed to connect the phase detector 802 such that a signal output from the detector 802 (e.g. an obtained and optionally divided down signal) controls operation of switch SW5. That is, the switch SW5 may be selectively opened and closed according to the frequency of this signal output from the detector 802. In turn, this may cause an impedance of the antenna 810 to be modulated according to this frequency. In other examples, the detector 802 could be replaced by LO circuitry configured to provide similar frequency switching of SW5.

The phase detector 802 may comprise a frequency divider configured to perform multiple of 2 division of the received incoming RF signal. The divider may be configured to perform multiple divisions (e.g. multiple divisions by two). For instance, the divider may be configured to perform a division by 32. The switch SW5 may then be controlled according to this frequency (i.e. according to the original incoming RF signal frequency divided by 32). As an example, the incoming carrier signal may be at (or close to) a frequency of 13.56 MHz and the resulting frequency for controlling switch SW5 may be 1/32^{th} of this—i.e. at (or close to) 423.75 KHz.

As will be appreciated in the context of the present disclosure, the device 800 need not perform both types of impedance change, i.e. both the smaller frequency higher impedance changes (SW1/SW2/SW3) and the higher frequency smaller impedance changes (SW4/SW5). Instead, only one of these options may be employed. Similarly, in the examples described above the RF communicator may be hidden until after authentication has occurred (e.g. switch SW6 may retain the communicator 840 disconnected from the antenna 810 until after authentication is complete).

However, in other examples of the present disclosure, RF communicators may be included which are configured to operate according to different modes of operation. In particular, communicators may have one or more pre-programmed ‘spoofing’ modes, as well as one or more RF communication protocol modes. In which case, switching between different modes of the communicator may be akin to switching between different communicators. In other words, a single RF communicator may be configured to operate as both a ‘dummy’ RF communicator and the RF communicator for following the relevant RF communication protocols. In which case, the RF communicator may be configured to only switch into the correct RF communication mode after authentication is complete (i.e. after sufficient power has been harvested in the spoofing mode for the authentication to have been performed). In this sense, one RF communicator may be provided which provides multiple different interfaces for interacting with the reader. Any sensitive information may only be transmitted once the authentication is complete.

As described herein, devices of the present disclosure may operate in the spoofing mode to cause another RF communications device (e.g. a reader) to maintain or increase the H-field it provides by mimicking certain interactions (e.g. tag-reader interactions). These may be smaller impedance variations which mimic interacting with the reader according to certain RF communication protocols, or they may be larger impedance variations which mimic a device first coming into proximity of the reader. This spoofing (or ‘reader prompting’) operation of the device prompts the reader into maintaining or increasing its H-field due to the interaction(s) it has mimicked.

The present disclosure may also comprise an RF communication device (e.g. a reader) which is configured to detect that an RF communications device (e.g. a tag) is acting in a spoofing mode. To avoid confusion, from hereon in, such an RF communications device will be referred to as a ‘reader’, but it will be appreciated that this could be implemented using any type of RF communications device.

The reader may be configured to detect that a device in its vicinity is operating in a spoofing mode. That is, the reader may be configured to detect one or more changes in antenna impedance of the device interacting with that reader. As mentioned above, this may comprise detecting a larger impedance change which occurs at a relatively lower frequency or a smaller impedance change which occurs at a relatively higher frequency. The reader may store one or more indications of known impedance change patterns (e.g. indicative of an amount of impedance change(s) and/or a frequency of such impedance change(s)). In the event that the detected impedance change(s) corresponds to a known impedance change associated with spoofing mode operation, the reader may determine that the device is operating in a spoofing mode. Additionally, or alternatively, the reader may be configured to determine that the device is operating in a spoofing mode by detecting the impedance changes and determining that the impedance changes are not following a known RF communication protocol. For example, the reader may be configured to determine that a device is operating in a spoofing mode in the event that it determines that the device appears to be trying to communicate with the reader, but with little or no meaningful information being communicated from the device to the reader.

In other words, the reader may be configured to detect that the device is interacting with that reader, but that the device is operating in a different manner to that which would typically be expected for communicating according to known RF communication protocols. For example, the reader may be configured to detect that the device is communicating in a manner which is different to that of a standard NDC communication protocol. While both the spoofing and the RF communicating may both involve providing changes in antenna impedance, the spoofing operation may do so in a way which does not following the behaviour expected according to the RF communication protocol. The reader may detect this similar, but different, behaviour of the device. The reader may be configured to determine that this deviation in approach to the normal RF communication indicates that the device is operating in a spoofing mode. The device may communicate in a manner different to the expected RF communication protocol, such as by operating in a communication standard outside of the NFC specification. Additionally, or alternatively, the spoofing mode operation of the device may comprise a signal requesting more power transmission. For example, the request may be for more power to be transmitted to the device (e.g. to enable authentication). The signal may comprise a request for a delayed communication time window with which the reader will accept communication with the device. For example, the delayed time window may enable sufficient time for authorisation to be performed (using the power harvested from the reader) and to then initiate the relevant RF communication protocol with the reader (before the reader stops communicating with the device).

In the event that the reader determines that the device with which it is interacting is operating in a spoofing mode, the reader is configured to maintain and/or increase its H-field. For example, the reader may be configured to continue providing its H-field for a selected amount of time after determining that the device is operating in a spoofing mode. The selected amount of time may comprise a time period of sufficient length for the authorisation process to finish. For example, the reader may maintain (or increase) the H-field until the device initiates communication according to an RF communication protocol or until the device stops attempting to communicate with the reader. Alternatively, the reader may continue providing its H-field for a preset amount of time. In the event that no RF communication protocol is initiated in that time period, then the reader may stop maintaining its H-field.

In other words, the reader may be configured to detect that a device is operating in a spoofing mode, and in that event, provide an H-field for the reader to perform its authorisation process using power harvested from that H-field. The reader may then communicate with the device according to the RF communication protocol if the authorisation process is successful, and if not, the reader may cease communication. For example, the reader may be configured to operate in one of several modes. A first mode may comprise a dormant (e.g. low power) mode, in which the reader commits relatively little, or even no, power to providing an H-filed. A second mode may comprise an RF communications mode in which the reader attempts to communicate with the device according to an RF communication protocol, and in the event that this does not work, in which the reader detects that the device is operating in a spoofing mode. A third mode may comprise a spoofing response mode, in which the reader maintains or increases its H-field while the device harvests power therefrom for authorisation. The reader may be configured to return to its RF communications mode in response to obtaining an indication that the authorisation process is complete and the device intends to communicate with the reader according to the RF communication protocol. After the RF communication protocol is finished and/or after obtaining an indication that the device is not intending to communicate according to the RF communication protocol, the reader may return to its dormant mode of operation.

It is to be appreciated in the context of the present disclosure that the examples described herein and shown in the Figs. should not be considered limiting. This material is instead intended to illustrate the general functionality of the present disclosure. For instance, in examples described herein there may be a number of different components which provide control circuitry for the device. For example, the device may include circuitry for controlling operation of the device (e.g. controller 50), circuitry to control operation to provide RF communication according to an RF communication protocol (e.g. RF communicator 40), circuitry for controlling operation of a local oscillator (e.g. a local oscillator controller), and/or circuitry specifically for controlling operation of the device in the spoofing mode (e.g. spoof controller 90). However, this breakdown should not be considered limiting. One or more of these may be provided by the same component (e.g. by a single chip/processor), or they may all be different components. Each of these components has been described as passive (i.e. passive chips), but it is to be appreciated that one or more could be active chips.

Examples of particular circuit topologies have been described herein, such as that shown in FIGS. 2 and 5. However, it is to be appreciated that this topology is just to provide an example of how such circuitry could be provided. Other arrangements could be used to provide rectifier and splitting functionality. Similarly, the devices of the present disclosure have been described as smart cards, but they could be used in other devices. Similarly, the disclosure typically relates to the device being a receiver (or ‘tag’) which is designed to communicate with a reader. However, devices of the present disclosure could be any suitable type, and they could be designed to interact with any other relevant RF enabled device. In examples described herein, the RF communication protocols may be NFC communication protocols. In examples, one or more components of the device may be controlled to oscillate at frequencies around a chip load modulation response of approximately 847.5 kHz. Additionally, or alternatively, when oscillation is used directly in the circuit (e.g. as shown in FIGS. 3 and 4), oscillation may be in a range of 13.56 MHz−847.5 kHz up to 13.56 MHz+847.5 kHz.

In FIGS. 3 to 5, LO circuitry 80 is shown which may be used by the device when operating in the spoofing mode. The LO circuitry 80 is intended to show one example. The LO circuitry 80 may generate an RF signal which is to be transmitted via an antenna 10 and detected by the reader. However, it is to be appreciated that the LO circuitry 80 could additionally or alternatively be provided by one or more components configured to operate in such a way that the operation of the device emulates that of a device actively transmitting RF signals. For example, the device may emulate this operation such that a reader may detect changes associated with the device which the reader infers are resulting from the device actively transmitting an RF signal (but where the device is actually not transmitting such signals). Similarly, in FIGS. 3 to 5, the disclosure relates to operating in the spoofing mode by controlling operation of the LO circuitry 80 for generating RF signals or causing changes in impedance to occur for the rectifier and splitter 30. However, this division should not be considered limiting. For example, the LO circuitry 80 could be connected to the device in a different manner, and/or a component may be connected to the device where the LO circuitry 80 is connected, and where that component is configured to operate to change an impedance of the device rather than to generate RF signals. Additionally, or alternatively, a switch for connecting and/or disconnecting the LO circuitry 80 could be used to provide the impedance changes. For example, such a switch could be selectively opened/closed to cause impedance changes (as well as then enabling the LO circuitry 80 to transmit the H field once the switch is closed).

It will be appreciated from the discussion above that the examples shown in the figures are merely exemplary, and include features which may be generalised, removed or replaced as described herein and as set out in the claims. With reference to the drawings in general, it will be appreciated that schematic functional block diagrams are used to indicate functionality of systems and apparatus described herein. In addition the processing functionality may also be provided by devices which are supported by an electronic device. It will be appreciated however that the functionality need not be divided in this way, and should not be taken to imply any particular structure of hardware other than that described and claimed below. The function of one or more of the elements shown in the drawings may be further subdivided, and/or distributed throughout apparatus of the disclosure. In some examples the function of one or more elements shown in the drawings may be integrated into a single functional unit.

As will be appreciated by the skilled reader in the context of the present disclosure, each of the examples described herein may be implemented in a variety of different ways. Any feature of any aspects of the disclosure may be combined with any of the other aspects of the disclosure. For example method aspects may be combined with apparatus aspects, and features described with reference to the operation of particular elements of apparatus may be provided in methods which do not use those particular types of apparatus. In addition, each of the features of each of the examples is intended to be separable from the features which it is described in combination with, unless it is expressly stated that some other feature is essential to its operation. Each of these separable features may of course be combined with any of the other features of the examples in which it is described, or with any of the other features or combination of features of any of the other examples described herein. Furthermore, equivalents and modifications not described above may also be employed without departing from the invention.

Certain features of the methods described herein may be implemented in hardware, and one or more functions of the apparatus may be implemented in method steps. It will also be appreciated in the context of the present disclosure that the methods described herein need not be performed in the order in which they are described, nor necessarily in the order in which they are depicted in the drawings. Accordingly, aspects of the disclosure which are described with reference to products or apparatus are also intended to be implemented as methods and vice versa. The methods described herein may be implemented in computer programs, or in hardware or in any combination thereof. Computer programs include software, middleware, firmware, and any combination thereof. Such programs may be provided as signals or network messages and may be recorded on computer readable media such as tangible computer readable media which may store the computer programs in non-transitory form. Hardware includes computers, handheld devices, programmable processors, general purpose processors, application specific integrated circuits (ASICs), field programmable gate arrays (FPGAs), and arrays of logic gates.

Other examples and variations of the disclosure will be apparent to the skilled addressee in the context of the present disclosure.

1. A near field RF communications enabled device comprising:
a coupler for connecting to a near field RF communications antenna for inductive coupling with an H-field provided from another near field RF communications enabled device in near field range;
auxiliary circuitry operable to obtain auxiliary data;
an RF communicator comprising stored instructions for communicating with a said another near field RF communications enabled device according to at least one RF communication protocol; and
a controller operable to selectively connect the RF communicator to the coupler for communicating with said another near field RF communications device according to a stored RF communication protocol;
wherein the device is configured to operate in:
a spoofing mode in which a spoofing signal is applied to at least one component of the device to cause said another RF communications device to maintain or increase the H field; and
an RF communications mode in which the RF communicator is connected to the coupler to communicate with said another RF communications device according to an RF communication protocol;
wherein the controller is configured to control the device to operate in the spoofing mode until the device has harvested enough power from the H field of said another RF communications device for the auxiliary circuitry to obtain auxiliary data; and
wherein the controller is configured to determine if the obtained auxiliary data satisfies a threshold criterion, and in the event that it does, the controller is configured to connect the RF communicator to the coupler to switch the device into the RF communications mode to communicate with said another RF communications device according to a stored RF communications protocol.

2. The device of claim 1, wherein the auxiliary circuitry comprises authentication circuitry operable to obtain authentication data for a user interacting with the device, and the selected criterion is an authentication criterion; and
wherein the controller is configured to determine that the obtained auxiliary data satisfies the threshold criterion in the event that the obtained authentication data indicates that said user interacting with the device is an authenticated user.

3. The device of claim 2, wherein the authentication circuitry comprises an authentication sensor, and wherein the authentication circuitry is configured to obtain authentication data for a user interacting with the authentication sensor.

4. The device of claim 3, wherein the authentication sensor comprises a biometric sensor, and wherein the auxiliary data comprises biometric data for a user interacting with the biometric sensor.

5. The device of claim 1, further comprising switching circuitry, and wherein applying a spoofing signal to a component of the device comprises applying a control signal to at least one switch of the switching circuitry to open or close said switch.

6. The device of claim 5, wherein said switch is arranged to cause an impedance of the device to change in response to that switch being opened and/or closed, and/or wherein said switch is arranged to connect the coupler to local oscillator circuitry, or to a component coupled to the local oscillator circuitry, of the device when closed.

7. The device of claim 5, wherein said switch is connected to a component of an antenna input impedance matching network of the device, and wherein opening and/or closing the switch causes a change in impedance of the device.

8. The device of claim 5 further comprising a rectifying element arranged to harvest power from RF signals received at a said antenna connected to the antenna, and wherein said switch is arranged between said antenna and the rectifying element, and/or connected to a component arranged between said antenna and the rectifying element.

9. The device of claim 1, wherein the RF communicator comprises stored secure data, and wherein the device is arranged to inhibit communication of said secure data to said another RF communications device until after the auxiliary data has been obtained and that obtained auxiliary data satisfies the threshold criterion.

10. The device of claim 1, wherein the device is arranged to inhibit the RF communicator initiating communication with said another near field RF communications device according to an RF communication protocol until after the auxiliary data has been obtained.

11. The device of claim 1, further comprising phase detection circuitry configured to detect a frequency of an incoming RF signal from a said another near field RF communications enabled device.

12. The device of claim 11, wherein the phase detection circuitry is configured to output a signal having a frequency based on the frequency of the incoming RF signal.

13. The device of claim 12, wherein the phase detection circuitry comprises a frequency divider configured to reduce a frequency of the incoming RF signal to provide the output signal.

14. The device of claim 12, wherein the device is configured to apply the output signal as the spoofing signal.

15. The device of claim 14, wherein the device is configured to apply the output signal to control operation of at least one switch.

16-31. (canceled)

32. A near field RF communications apparatus comprising:
a first near field RF communications enabled device operable to provide an H-field for near field communication with another RF communications device; and
a second near field RF communications enabled device configured for inductive coupling with said H-field;
wherein the second RF communications device is configured to operate in a spoofing mode and an RF communications mode; and
wherein the first RF communications device is configured to determine whether the second RF communications device is operating in the spoofing mode, and in the event that it is determined that the second RF communications device is operating in the spoofing mode, the first RF communications device is configured to maintain or increase its H-field.

33. The apparatus of claim 32, wherein the second near field RF communications device comprises a coupler for connecting to a near field RF communications antenna for inductive coupling with an H-field provided from another near field RF communications enabled device in near field range;
auxiliary circuitry operable to obtain auxiliary data;
an RF communicator comprising stored instructions for communicating with a said another near field RF communications enabled device according to at least one RF communication protocol; and
a controller operable to selectively connect the RF communicator to the coupler for communicating with said another near field RF communications device according to a stored RF communication protocol;
wherein the device is configured to operate in:
a spoofing mode in which a spoofing signal is applied to at least one component of the device to cause said another RF communications device to maintain or increase the H field; and
an RF communications mode in which the RF communicator is connected to the coupler to communicate with said another RF communications device according to an RF communication protocol;
wherein the controller is configured to control the device to operate in the spoofing mode until the device has harvested enough power from the H field of said another RF communications device for the auxiliary circuitry to obtain auxiliary data; and
wherein the controller is configured to determine if the obtained auxiliary data satisfies a threshold criterion, and in the event that it does, the controller is configured to connect the RF communicator to the coupler to switch the device into the RF communications mode to communicate with said another RF communications device according to a stored RF communications protocol.

34. A near field RF communications device configured to provide an H-field for near field communication with another RF communications device;
wherein the RF communications device is configured to determine whether a said another RF communications device inductively coupling with the device is operating in a spoofing mode, and in the event that it is determined that said another RF communications device is operating in the spoofing mode, the RF communications device is configured to maintain or increase its H-field.

35-37. (canceled)

38. The apparatus of claim 32, wherein the auxiliary circuitry comprises authentication circuitry operable to obtain authentication data for a user interacting with the device, and the selected criterion is an authentication criterion; and
wherein the controller is configured to determine that the obtained auxiliary data satisfies the threshold criterion in the event that the obtained authentication data indicates that said user interacting with the device is an authenticated user.
